(19) United States
(12) Patent Application Publication
(10) Pub. No.: US 2011/0112250 A1
(43) Pub. Date: May 12, 2011

(54) MOISTURE CROSSLINKABLE POLYETHYLENE COMPOSITION

(75) Inventors: Mohamed Esseghir, Monroe Township, NJ (US); Jeffrey M. Cogen, Flemington, NJ (US); Robert F. Eaton, Belle Mead, NJ (US); Michael B. Biscoglio, Piscataway, NJ (US); Salvatore F. Shurott, Freehold, NJ (US)

(73) Assignee: Union Carbide Chemicals & Plastics Technology LLC, Midland, MI (US)

(21) Appl. No.: 13/002,059

(22) PCT Filed: Jun. 29, 2009
(86) PCT No.: PCT/US2009/049065

§ 371 Date: Dec. 30, 2010

Related U.S. Application Data
(60) Provisional application No. 61/076,952, filed on Jun. 30, 2008.

(51) Int. Cl. C08J 3/24; C08L 23/02

(52) U.S. Cl. 525/193; 525/191

(57) ABSTRACT

The present invention is a moisture crosslinkable composition. It may be (i) a blend of a nonpolar polyolefin and a second highly polar or amorphous polyolefin or (ii) a copolymer of a nonpolar polyolefin and the second polar or amorphous polyolefin. The present invention is useful for the preparation of moisture-cured wires, cables, film, pipe, hot melt adhesives, and other extruded or injection molded articles. The present invention is also useful in the preparation of media for fast transport of selective species, including film membranes.

The present invention relates to moisture crosslinkable compositions. More specifically, the present invention relates to moisture crosslinkable blends of a nonpolar polyolefin and highly polar or amorphous polyolefins.

Moisture crosslinking using a direct process (grafting silane and making the article simultaneously), a silane pre-grafted resin, or a reactor copolymer requires the use of high temperature cure media such as steam or sauna. Furthermore, the direct moisture crosslinking process is control intensive. It requires handling silane and peroxide, accurate metering, and technical know-how to ensure the quality of the finished articles.

For the moisture crosslinking process that uses a silane pre-grafted resin, the grafting step is performed in a reactive extrusion line and adds cost. Furthermore, the silane pre-grafted resin has a limited shelf-life when compared to a reactor copolymer product.

Under ambient conditions, the cure rate of a polyethylene composition is slow (1-2 weeks) which limits productivity. When ambient cure technologies use fast, expensive catalysts, the crosslinkable polyethylene composition is subjected to premature crosslinking. To prevent premature crosslinking, scorch control additives are used and further increase the overall cost of the system.

There is a need for a crosslinkable polyethylene composition that (a) does not require a reactive extrusion step, (b) yields a smooth, uniform article, (c) does not require intensive control, and (d) permits fast curing in hot water or under ambient conditions.

The present invention achieves these aims and others. It comprises a first polyolefin and a second polyolefin. The second polyolefin is selected from polar polyolefins, amorphous polyolefins, and mixtures thereof. The second polymer may be finely dispersed or copolymerized with the first polymer.

Without being bound to any specific theory, it is believed that this invention uses solubility property of a polar or highly amorphous phase to absorb high level of silane/peroxide to enable fast incorporation in a polyolefin phase.

When a polar polyolefin or a highly amorphous polyolefin is finely dispersed in a base polyolefin according to the present invention, (a) the soaking time of the crosslinking agents is reduced by 10× over the base resin, (b) extruding the composition produces a smooth wire surface, and (c) crosslinking occurs at a rate faster than that achieved with a grafted or a reactor silane copolymer. Additionally, it is noted that crosslinking a composition of the present invention under ambient conditions with standard levels of a dibutyltin dilaurate (DBTDL) catalyst occurs faster than crosslinking of the conventional system using moisture-crosslinking catalysts such as sulfonic acid.

It is believed that the present invention will permit (1) the use of shorter extrusion lines, (2) longer production times, and (3) the use of economical hindered phenol antioxidants that presently cannot be used with sulfonic acids.

The present invention is useful for the preparation of moisture-cured wires, cables, film, pipe, hot melt adhesives, and other extruded or injection molded articles. The present invention is also useful in the preparation of media for fast transport of selective species, including film membranes.

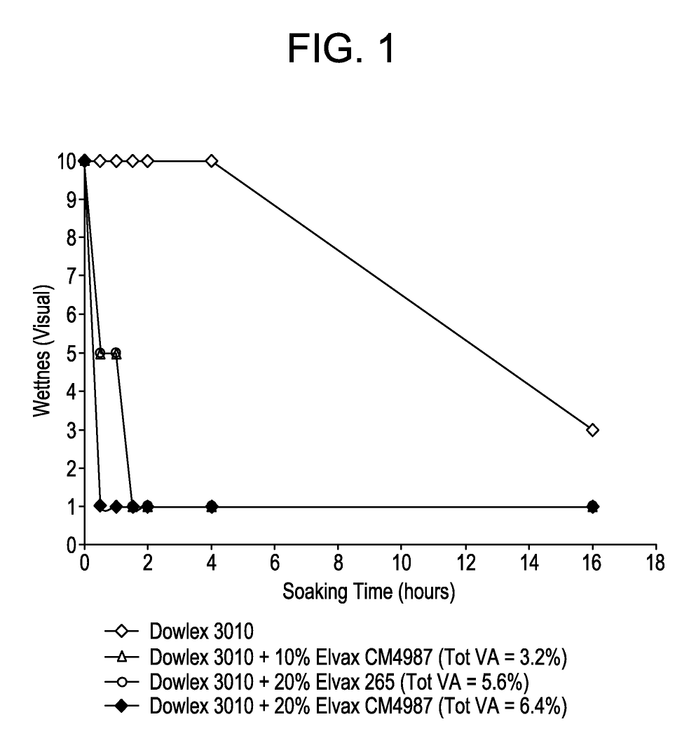

FIG. 1 shows the effect of adding a polar polyolefin to a nonpolar polyolefin on the relationship between soaking time and the resulting degree of wetness following the addition of a vinyl alkoxysilane and an organic peroxide.

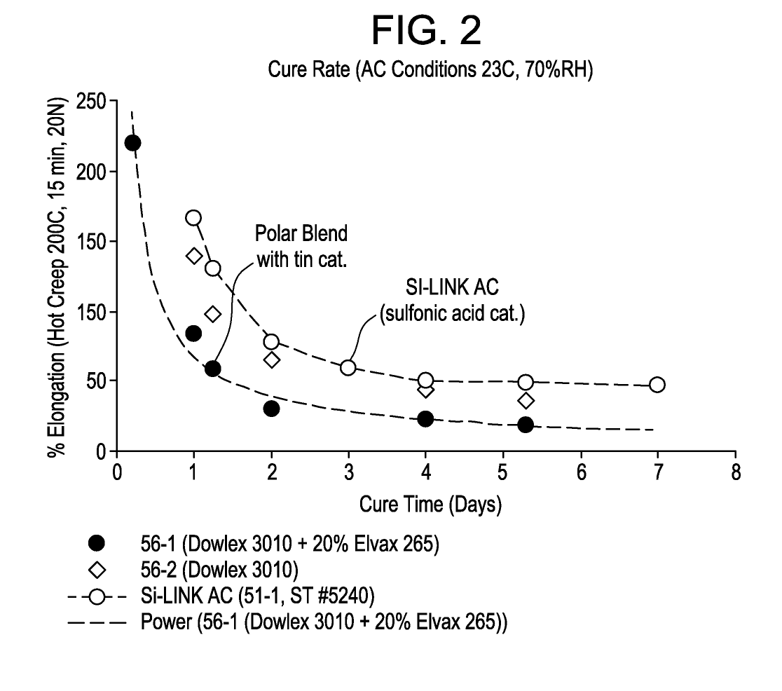

FIG. 2 shows the effect of adding a polar polyolefin to a nonpolar polyolefin on the relationship of cure time (at ambient conditions) and hot creep elongation, including a comparison with a moisture crosslinkable composition containing a sulfonic acid catalyst.

The crosslinkable composition of the present invention comprises (1) a first polyolefin, (2) a second polyolefin, (3) a vinyl alkoxysilane, and (4) an organic peroxide. The second polyolefin is selected from polar polyolefins, amorphous polyolefins, and mixtures thereof. The second polymer may be finely dispersed or copolymerized with the first polymer.

Suitable first polyolefins include polyethylene and polypropylene. Polyethylene polymer, as that term is used herein, is a homopolymer of ethylene or a copolymer of ethylene and a minor proportion of one or more alpha-olefins having 3 to 12 carbon atoms, and preferably 4 to 8 carbon atoms, and, optionally, a diene, or a mixture or blend of such homopolymers and copolymers. The mixture can be a mechanical blend or an in situ blend. Examples of the alpha-olefins are propylene, 1-butene, 1-hexene, 4-methyl-1-pentene, and 1-octene.

The polyethylene can be homogeneous or heterogeneous. The homogeneous polyethylenes usually have a polydispersity (Mw/Mn) in the range of 1.5 to 3.5 and an essentially uniform comonomer distribution, and are characterized by a single and relatively low melting point as measured by a differential scanning calorimeter. The heterogeneous polyethylenes usually have a polydispersity (Mw/Mn) greater than 3.5 and lack a uniform comonomer distribution. Mw is defined as weight average molecular weight, and Mn is defined as number average molecular weight.

The polyethylenes can have a density in the range of 0.860 to 0.970 gram per cubic centimeter, and preferably have a density in the range of 0.870 to 0.930 gram per cubic centimeter. They also can have a melt index in the range of 0.1 to 50 grams per 10 minutes. If the polyethylene is a homopolymer, its melt index is preferably in the range of 0.75 to 3 grams per 10 minutes. Melt index is determined under ASTM D-1238. Condition E and measured at 190 degrees Celsius and 2160 grams.

Low- or high-pressure processes can produce the polyethylenes. They can be produced in gas phase processes or in liquid phase processes (i.e., solution or slurry processes) by conventional techniques. Low-pressure processes are typically run at pressures below 1000 pounds per square inch (“psi”) whereas high-pressure processes are typically run at pressures above 15,000 psi.

Typical catalyst systems for preparing these polyethylenes include magnesium/titanium-based catalyst systems, vanadium-based catalyst systems, chromium-based catalyst systems, metallocene catalyst systems, and other transition metal catalyst systems. Many of these catalyst systems are often referred to as Ziegler-Natta catalyst systems or Phillips catalyst systems. Useful catalyst systems include catalysts using chromium or molybdenum oxides on silica-alumina supports.

Useful polyethylenes include low density homopolymers of ethylene made by high pressure processes (HP-LDPEs), linear low density polyethylenes (LLDPEs), very low density polyethylenes (VLDPEs), ultra low density polyethylenes (ULDPEs), medium density polyethylenes (MDPEs), high density polyethylene (HDPE), and metallocene copolymers.

High-pressure processes are typically free radical initiated polymerizations and conducted in a tubular reactor or a stirred autoclave. In the tubular reactor, the pressure is within the range of 25,000 to 45,000 psi and the temperature is in the range of 200 to 350 degrees Celsius. In the stirred autoclave, the pressure is in the range of 10,000 to 30,000 psi and the temperature is in the range of 175 to 250 degrees Celsius.

The VLDPE or ULDPE can be a copolymer of ethylene and one or more alpha-olefins having 3 to 12 carbon atoms and preferably 3 to 8 carbon atoms. The density of the VLDPE or ULDPE can be in the range of 0.870 to 0.915 gram per cubic centimeter. The melt index of the VLDPE or ULDPE can be in the range of 0.1 to 20 grams per 10 minutes and is preferably in the range of 0.3 to 5 grams per 10 minutes. The portion of the VLDPE or ULDPE attributed to the comonomer(s), other than ethylene, can be in the range of 1 to 49 percent by weight based on the weight of the copolymer and is preferably in the range of 15 to 40 percent by weight.

A third comonomer can be included, e.g., another alpha-olefin or a diene such as ethylene norbornene, butadiene, 1,4-hexadiene, or a dicyclopentadiene. Ethylene/propylene copolymers are generally referred to as EPRs and ethylene/propylene/diene terpolymers are generally referred to as an EPDM. The third comonomer can be present in an amount of 1 to 15 percent by weight based on the weight of the copolymer and is preferably present in an amount of 1 to 10 percent by weight. It is preferred that the copolymer contains two or three comonomers inclusive of ethylene.

The LLDPE can include VLDPE, ULDPE, and MDPE, which are also linear, but, generally, has a density in the range of 0.916 to 0.925 gram per cubic centimeter. It can be a copolymer of ethylene and one or more alpha-olefins having 3 to 12 carbon atoms, and preferably 3 to 8 carbon atoms. The melt index can be in the range of 1 to 20 grams per 10 minutes, and is preferably in the range of 3 to 8 grams per 10 minutes.

Any polypropylene may be used in these compositions. Examples include homopolymers of propylene, copolymers of propylene and other olefins, and terpolymers of propylene, ethylene, and dienes (e.g. norbornadiene and decadiene). Additionally, the polypropylenes may be dispersed or blended with other polymers such as EPR or EPDM. Suitable polypropylenes include TPEs, TPOs and TPVs. Examples of polypropylenes are described in POLYPROPYLENE HANDBOOK: POLYMERIZATION, CHARACTERIZATION, PROPERTIES, PROCESSING, APPLICATIONS 3-14, 113-176 (E. Moore, Jr. ed., 1996).

Suitable second polyolefins include polar polyolefins and amorphous forms of the first polyolefins. Examples of polar polyolefins are copolymers of ethylene and an unsaturated ester such as a vinyl ester (e.g., vinyl acetate or an acrylic or methacrylic acid ester).

Copolymers comprised of ethylene and unsaturated esters are well known and can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. Preferably, the unsaturated ester will be present in a amount between about 1.0 weight percent and about 3.0 weight percent.

Suitable vinyl alkoxysilanes include, for example, vinyltrimethoxysilane and vinyltriethoxysilane. Preferably, the vinyl alkoxysilane will be present in an amount between about 1.0 weight percent and about 2.0 weight percent.

For example, suitable organic peroxides include dialkyl peroxides, dicumyl peroxide, and Vulcup R. Preferably, the organic peroxide is present in an amount between about 0.03 weight percent and about 5.0 weight percent, more preferably, between about 0.05 weight percent and about 2.0 weight percent, even more preferably, between about 0.05 weight percent and about 1.0 weight percent and most preferably, between about 0.05 weight percent and about 0.08 weight percent.

The present composition may further comprise suitable antioxidants, including (a) phenolic antioxidants, (b) thio-based antioxidants, (c) phosphate-based antioxidants, and (d) hydrazine-based metal deactivators. Suitable phenolic antioxidants include methyl-substituted phenols. Other phenols, having substituents with primary or secondary carbonyls, are suitable antioxidants. A preferred phenolic antioxidant is isobutylidenebis(4,6-dimethylphenol). A preferred hydrazine-based metal deactivator is oxalyl bis(benzylidiene hydrazide). Preferably, the antioxidant is present in amount between 0.05 weight percent to 10 weight percent of the polymeric composition.

The composition may further comprise polyvinyl chloride, acrylics, polyamides, polyesters, polyester urethanes, shape-memory polymers, carbon black, colorants, corrosion inhibitors, lubricants, anti-blocking agents, flame retardants, and processing aids.

In an alternate embodiment, the invention is wire or cable construction prepared by applying the polymeric composition over a wire or cable.

In another embodiment, the present invention provides a process for making a crosslinked article. The process permits crosslinking at ambient conditions of temperature and humidity, without the use of a sulfonic acid catalyst or the acid-catalyzed destruction of hindered phenol antioxidants.

### EXAMPLES

The following non-limiting examples illustrate the invention.

TABLE 1

| Component | | | | |
|---|---|---|---|---|
| (weight percent) | Example 1 | Example 2 | Example 3 | Comp. Ex. 4 |
| Dowlex 3010 + 20 | 97.92 | | | |
| wt % Elvax 265 | | | | |
| Dowlex 3010 + 20 | | 97.92 | | |
| wt % Elvax CM 4987 | | | | |
| Dowlex 3010 + 10 | | | 97.92 | |
| wt % Elvax CM 4987 | | | | |
| Dowlex 3010 | | | | 97.92 |
| Soaking Time | Condition of Pellets | | | |
| Initial | Wet | Wet | Wet | Wet |
| 0.5 hr | Slight | Dry | Slight | Wet |
| | residue | | residue | |
| 1 hr | Slight | Dry | Slight | Wet |
| | residue | | residue | |
| 1.5 hr | Dry | Dry | Dry | Wet |
| 2 hr | Dry | Dry | Dry | Wet |
| 4 hr | Dry | Dry | Dry | Wet |
| 16 hr | Dry | Dry | Dry | Trace |
| | | | | residue |

% LEL (time at 40 degrees Celsius, then room temperature)

| | | | | |
|---|---|---|---|---|
| 2 hrs | 0 | 1 | 1 | 1 |
| 88 hrs | 0 | 0 | 0 | 0 |

% LEL (time at 60 degrees Celsius, then room temperature)

| | | | | |
|---|---|---|---|---|
| 1 week | 0 | 1 | 1 | 1 |

Extruder Head Pressure (PSI)

| | | | |
|---|---|---|---|
| 1520 | 1340 | 1260 | 1180 |

Wire Surface Smoothness Rating

| | | | |
|---|---|---|---|
| 1.3 | 3.3 | 2.3 | 2.3 |

Each of the exemplified compositions in Table 1 were prepared using 2.0 weight percent of vinyltrimethoxysilane and 0.08 weight percent of LUPEROX 101 organic peroxide. The polymers were conditioned for 2 hours at 40 degrees Celsius.

TABLE 2
Hot Creep (% Elongation, 200 degrees Celsius, 15 minutes)

| | | | |
|---|---|---|---|
| Example 1 | Example 2 | Example 3 | C. Ex. 4 |

Cure in 90 degrees Celsius water

| | | | | |
|---|---|---|---|---|
| 1 hr | 31/29/27 | 27/26/25 | 29/35/30 | 27/29/34 |
| 16 hrs | 24/25/20 | 22/24/24 | 18/23/21 | 24/21/31 |
| Tensile (Peak stress @ | 2511 | 2121 | 1745 | 2523 |
| break) | | | | |
| % Elongation | 328 | 331 | 286 | 382 |

Ambient cure at 23 degrees Celsius, 70% relative humidity

| | | | | |
|---|---|---|---|---|
| 50 hours (2.1 days) | 30 | 40 | 40 | 65 |

TABLE 3

| Component (weight percent) | Comp. Example 5 | Example 6 |
|---|---|---|
| DFDA-5451 | 95.00 | |
| 2647B + 10 wt % Engage 8200 | | 92.92 |
| Soaking Time | Condition of Pellets | |
| Initial | | Wet |
| 0.5 hr | | Slight residue |
| 1.0 hr | | Dry |
| Wireline Extruder Temp Profile | Standard | High |
| Extruder Head Pressure (PSI) | 1150 | 1570 |
| Wire Surface Smoothness Rating | 1.5 | 2 |

Hot Creep Test @ 200 degrees Celsius, 15 minutes (% Elongation)
Cure in 90 degrees Celsius water

| | | |
|---|---|---|
| 1 hr | 76 | 17.3 |
| 4 hr | 54.5 | 17 |

Ambient cure (23 degrees Celsius, 70% relative humidity)

| | | |
|---|---|---|
| 2 days | Break/Fail | 26 |
| 4 days | 195 | 32 |

Each of the exemplified compositions in Table 3 were prepared using 2.0 weight percent of vinyltrimethoxysilane, 0.08 weight percent of LUPEROX 101 organic peroxide, and 5.0 weight percent of DFDB-5481 catalyst masterbatch. The polymers were conditioned for 2 hours at 40 degrees Celsius.

1. A moisture crosslinkable composition comprising:
a polymeric matrix comprising a first polyolefin;
a second polyolefin selected from the group consisting of polar polyolefins and amorphous polyolefins, dispersed in the polymeric matrix;
a vinyl alkoxysilane; and
an organic peroxide.

2. (canceled)

3. The moisture crosslinkable composition of claim 1 wherein the organic peroxide is present in amount between 0.05 weight percent and 0.08 weight percent.

4. A process for moisture crosslinking a polyolefinic composition consisting essentially of the steps of:
selecting a first polyolefin;
selecting a second polyolefin;
dispersing the second polyolefin into the first polyolefin to form a polyolefinic composition;
absorbing silane into the second polyolefin;
absorbing an organic peroxide into the second polyolefin;
admixing a moisture-crosslinking catalyst; and
crosslinking the polyolefinic composition.

5. (canceled)

6. The process of claim 4 wherein the crosslinking step occurs at ambient temperature and humidity.
